(19) United States
(12) Patent Application Publication
(10) Pub. No.: US 2014/0115745 A1
(43) Pub. Date: May 1, 2014

(54) Metal Reinforced Ballistic Helmet

(71) Applicant: Mark Martinez, Atwater, CA (US)

(72) Inventor: Mark Martinez, Atwater, CA (US)

(21) Appl. No.: 13/662,547

(22) Filed: Oct. 29, 2012

(51) Int. Cl. F41H 1/04; B32B 37/12; B32B 37/10

(52) U.S. Cl. 2/6.6; 156/60; 89/913; 89/914

(57) ABSTRACT

A combat helmet may be constructed of a composite material with embedded metal plates Inner and outer shells of woven fibers bound with a thermoset or thermoplastic composite may sandwich titanium or other metal plates to form the helmet. The fibers may include aramid and other fibers that may be laid up in multiple layers. The helmet may be composed of multiple flat faces, and the metal plates may be sheet metal components.

### BACKGROUND

Helmets have been worn by armies for centuries. The combat helmet protects a user from projectiles and other impact. Today's infantry combat helmet also serves as a mounting platform for flashlights, communications gear, and other accessories.

### SUMMARY

A combat helmet may be constructed of a composite material with embedded metal plates Inner and outer shells of woven fibers bound with a thermoset or thermoplastic composite may sandwich titanium or other metal plates to form the helmet. The fibers may include aramid and other fibers that may be laid up in multiple layers. The helmet may be composed of multiple flat faces, and the metal plates may be sheet metal components.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a helmet.

FIG. 2 is a cross-sectional diagram illustration of an embodiment showing a portion of a helmet.

FIG. 3 is a diagram illustration of an embodiment showing an assembly procedure for a helmet.

### DETAILED DESCRIPTION

A combat helmet may be formed from a composite material sandwiching metal plates. In one embodiment, the helmet may have flat or planar facets in which sheet metal components may be embedded. The metal plates may be titanium or other metal, and may provide a large amount of ballistic protection with a minimum of weight.

The inner and outer composite material may be an aramid fiber in a thermoset or thermoplastic material. In some embodiments, carbon or other fiber material may be used. In some embodiments, ultra high molecular weight polyethylene fibers may be used.

The metal plates may be sheet metal components as thin as 0.020 in, which may be individual flat plates, or a formed component that may cover multiple flat facets. Such formed components may be brake formed, hydroformed, stamped, drawn, or manufactured with some other process.

The metal plates may be continuous or may have holes or other openings. Plates with openings may be useful to join the inner and outer layers to minimize delamination.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

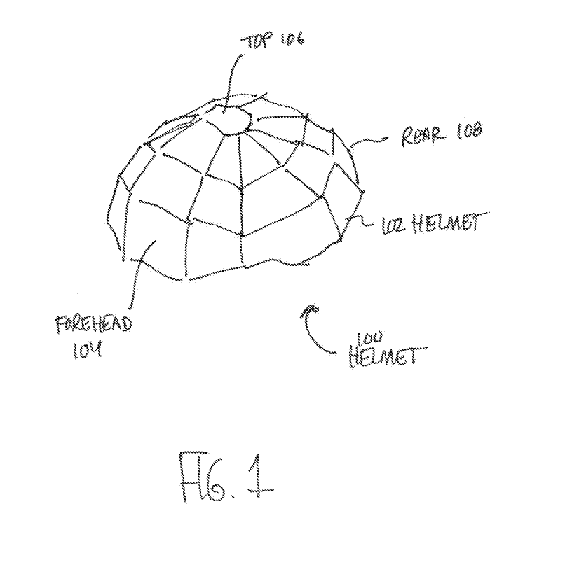

FIG. 1 is an illustration of an embodiment 100 showing a helmet 102. The helmet 102 is oriented to show the forehead region 104, the top 106, and the rear 108. The helmet 102 may be constructed from multiple layers of woven fiber material with metal plates or sheet sandwiched between the fiber layers.

The fiber material may be any type of fiber composite material, such as aramid fibers, carbon fibers, glass fibers, polyamide nylon fibers, polyester fibers, olefin fibers, or other reinforcing fibers.

The helmet 102 may be manufactured with some number of layers of woven fiber material on the outside surface, one or more metal plates, and some number of layers of woven fiber material on the inner surface.

The woven fiber material offers good ballistic protection, as the woven material may absorb impact of bullets and other projectiles by spreading the impact through the woven material. The sandwiched metal sheet may provide further ballistic resistance, especially when the metal sheet may be backed up by an internal layer or layers of woven material.

In several ballistic tests, the metal sheets or plates in a test helmet were a significant improvement to ballistic survivability. The metal sheets helped redirect off-angle impacts by redirecting the path of a bullet. In such cases, a bullet may pierce the outer layers of woven material, then be redirected along the surface of the metal plate and travel some distance between the plate and the outer layers before coming to rest. Such behavior causes an impacting bullet to be slowed down over some distance, resulting in lower forces being transmitted to the wearer's head.

Further, the inner layer of woven material appear to act as a resilient mechanical support for the thin metal plates on direct ballistic impact. In such impact, a bullet impacting the helmet at a perpendicular direction may be stopped while spreading out the deflection zone over a wide area. In comparison, a similarly manufactured helmet without the metal reinforcements has a smaller but deeper impact zone than the metal reinforced helmet.

The metal sheet reinforcement may be any suitable metal, such as titanium, steel, aluminum, magnesium, or other metals or alloys. Titanium may be used in many cases. The thickness of the metal reinforcement may range from 0.005 in, 0.010 in, 0.015 in, 0.025 in, 0.030 in, 0.040 in, 0.050 in, or larger. In some cases, the metal reinforcement may be 0.060 in, 0.070 in, or thicker. In some cases, the metal reinforcement may be thinner than 0.005 in. The metal reinforcement may be heat treated or undergo various processing prior to helmet manufacture.

The outer layers of woven material may range from a single layer of woven material, to two, three, four, five, or more layers. In some embodiments, 8, 10, 12, 14, 16, 18, 20, or more layers may be used as outside layers. Some embodiments may use different fiber types in various layers. For example, an outer woven aramid fiber layer may be used with a second layer of woven carbon fiber material and so forth.

The inner layers of woven material may range from a single layer of woven material, to two, three, four, five, or more layers. In some embodiments, 8, 10, 12, 14, 16, 18, 20, or more layers may be used as outside layers. As described for the outer layers, some embodiments may use different fiber types in various layers.

The inner and outer layers of woven material may be held together using some form of binder. Such binders may be thermoset or thermoplastic polymers or other materials. In some cases, the woven material may be preimpregnated with resin or binder, and the layers may be processed using heat and pressure to cure the binder. In some cases, the binder material may be added separately, such as using resin transfer molding or other process.

In some cases, the metal reinforcements may have connection mechanisms to various external and internal components. For example, a metal plate in a helmet may include a threaded receiver for a fastener for mounting an internal suspension system for attaching the helmet to a wearer's head, or for mounting external components such as lights, cameras, and communication gear.

The metal reinforcements may include holes or openings through which the inner and outer woven layers may bond to each other.

The helmet 102 is illustrated with multiple flat facets. Each facet may be reinforced with a flat metal plate which may or may not be continuous with an adjacent plate. In some embodiments, some of the facets may be formed to have a slightly rounded contour. In such embodiments, the corresponding metal reinforcement may be formed to follow the same contour.

In some embodiments, different thicknesses of metal may be used in different locations. For example, the forehead area 104 may have metal reinforcements that are thicker than those in the top 106 or rear 108.

The helmet 102 may have between 15 and 40 facets. Other embodiments may have more or fewer flat facets, while still other embodiments may have no facets and may be curved all over. In many embodiments, the flat facets may cover 75% or more of the overall surface of the helmet.

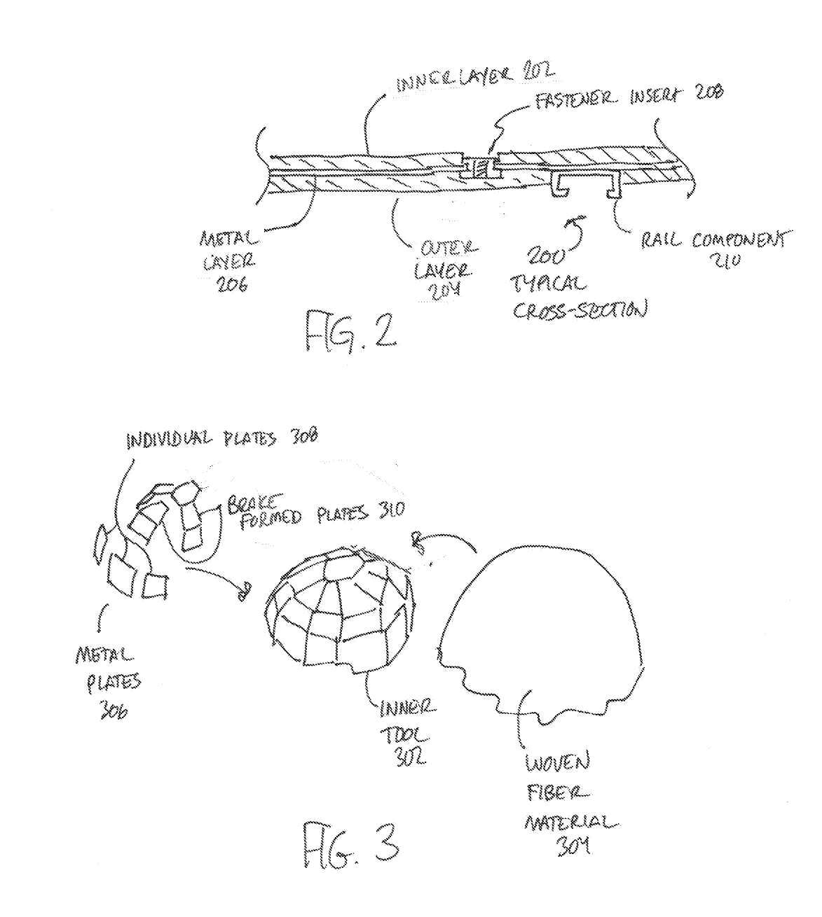

FIG. 2 is a cross-sectional illustration of an embodiment 200 showing a representative helmet cross section having an inner layer 202, an outer layer 204, and a metal layer 206. FIG. 2 is not to scale.

The cross-section of embodiment 200 may illustrate that the sandwich construction of a helmet, where the metal layer 206 may be captured between the inner and outer layers of composite material. In many cases, the entire helmet, including the inner and outer layers and the metal layer, may be formed in a single manufacturing step by curing or consolidating the binder of both the inner and outer layers simultaneously.

While the inner and outer layers appear to be approximately the same thickness in the illustration, in practice, one layer may be thicker than the other. For example, some embodiments may have, for example, 10 layers of woven fiber material that make up the outer layer 204 and 20 layers of woven fiber material that make up the inner layer 202.

In some embodiments, the metal layer 206 may contain fasteners or other components that may be accessed through one of the layers. For example, a fastener insert 208 may be a sheet metal fastener that may be press fit into the metal layer 206 prior to curing the helmet. The inner layer 202 may have a hole through the woven material so that a screw or other fastener may attach to the fastener insert 208. Such a fastener may attach a harness that may hold the helmet to a wearer's head.

In another example, a rail component 210 may be attached to the metal layer 206 and may be accessed from the outer side of the helmet. The rail component 210 may be spot welded or otherwise attached to the metal layer 206. In use, the rail component 210 may be a mechanism by which various accessories may be attached to the helmet. The accessories may be items such as communications gear, flashlights, cameras, and the like.

FIG. 3 is a diagram illustration of an embodiment 300 showing the construction of a metal reinforced helmet. The example of embodiment 300 shows the construction with an inner tool 302 over which the helmet may be manufactured and formed. A series of layers of woven fiber material 304 may be laid up on top of the inner tool 302, and then various metal plates 306 may be added. Additional layers of woven fiber material 304 may be placed on top of the metal plates 306 and the entire assembly may be cured, consolidated, or otherwise bonded together. In many such manufacturing processes, a vacuum bag may be applied over the entire assembly during bonding. A vacuum bag may be a mechanism by which external gas pressure may be applied during curing or bonding.

Embodiment 300 illustrates an example where an inner, male tool may be used to lay up a helmet. In some cases, an outer, female tool may be used. In some embodiments, an outer tool may provide a more crisply defined outer shape than when an inner tool may be used. In still other cases, both an inner and outer tool may be used. In such cases, the tools may be placed in a press during curing.

The metal plates 306 may be provided as individual plates 308, as brake formed plates 310, or in some other configuration.

The individual plates 308 may be separately cut to shape and individually placed in or on the woven fiber material 304 during assembly. In such embodiments, each individual plate may be of a different thickness or different material, as each metal plate may be cut from different raw material. Because the helmet may have several flat, planar surfaces, each plate may be manufactured and cut from sheet metal and placed in a corresponding planar surface during assembly.

The examples of brake formed plates 310 may illustrate formed metal components that may cover two or more of the various planar surfaces of the helmet. Such formed components may make assembly of the helmet simpler and more efficient, as the parts may be less likely to shift during assembly and manufacturing.

The brake formed plates 310 are merely one example of a manufacturing method by which multiple metal facets may be made. In other embodiments, a metal plate may be stretch formed, blow formed, super plastic formed, drawn, or otherwise molded into shape. The metal component may be formed, then trimmed into shape for assembly into a helmet. In the case of components with fastener inserts, rail components, or other attachments, such attachments may be assembled to the metal plates prior to assembly into the helmet.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A helmet comprising:
an outer layer of a first woven fiber material bonded with a binder;
an inner layer of a second woven fiber material bonded with said binder; and
a plurality of metal components between said inner layer and said outer layer and fully encapsulated by said inner and outer layer.

2. The helmet of claim 1, said binder being a thermoset polymer.

3. The helmet of claim 2, said helmet having a faceted shape comprising a plurality of planar surfaces.

4. The helmet of claim 3, said helmet having between 15 and 40 of said planar surfaces.

5. The helmet of claim 3, said helmet having an outer surface comprising at least 75% being said planar surfaces.

6. The helmet of claim 1, said plurality of metal components being sheet metal components.

7. The helmet of claim 6, said metal components being titanium.

8. The helmet of claim 7, said metal components comprising a first set of components with a first thickness and a second set of components with a second thickness, said first thickness being larger than said second thickness.

9. The helmet of claim 8, said first set of components being located in a forehead area of said helmet.

10. The helmet of claim 1, said outer layer comprising less than 10 layers of said first woven fiber material and said inner layer comprising at least 5 layers of said second woven fiber material.

11. The helmet of claim 10, said outer layer comprising less than 5 layers of said first woven fiber material.

12. The helmet of claim 10, at least one of said metal components having a fastener connection for a removable component.

13. The helmet of claim 12, said removable component being an inner suspension mountable to a wearer's head.

14. A method for manufacturing a helmet, said method comprising:
laying up a first set of layers of woven fiber material on a form;
placing a plurality of planar metal components on said first set of layers of woven fiber material;
laying up a second set of layers of said woven fiber material; and
processing to join said first set and second set of layers of said woven fiber and said plurality of planar metal components using a polymer binder.

15. The method of claim 14, said polymer binder being a thermoset resin incorporated into said first set of layers and second set of layers prior to said laying up.

16. The method of claim 15, said processing comprising processing under pressure and heat.

17. The method of claim 16, said pressure being applied by an inner tool and an outer tool.

18. The method of claim 17, said pressure being applied by an inner tool and external gas pressure.

19. The method of claim 17, said pressure being applied by an outer tool and external gas pressure.
